(19) United States
(12) Patent Application Publication
(10) Pub. No.: US 2004/0246906 A1
(43) Pub. Date: Dec. 9, 2004

(54) Methods and systems for accelerating inference engines used in expert systems

(76) Inventor: William Christopher Hardy, Dallas, TX (US)

Correspondence Address: SLATER & MATSIL, L.L.P., 17950 PRESTON RD, SUITE 1000, DALLAS, TX, 75252-5793, US

(21) Appl. No.: 10/456,358

(22) Filed: Jun. 6, 2003

(51) Int. Cl. H04L 12/26

(52) U.S. Cl. 370/252; 370/254

(57) ABSTRACT

A computer-implemented method determines relationships between facts. A driver matrix is created from a set of facts and a set of rules applying to the facts. Each entry in the driver matrix indicates whether one of the facts implies another one of the facts. Each of the facts comprises a observable fact relating to a physical object or activity. The driver matrix is multiplied by itself to derive a consequent matrix. The driver matrix is then compared to the consequent matrix to determine relationships between facts in the set of facts.

### FIELD OF THE INVENTION

This invention relates generally to computer-implemented inferencing methods and systems and more specifically to methods and systems for accelerating inference engines used in expert systems.

### BACKGROUND OF THE INVENTION

A relationship between two objects or conditions is an assertion of the form A R B, where R is transitive. An example of this type of relationship is the assertion “if A then B” found in an application of “artificial intelligence” known as expert systems, which utilize rules formulated in this way to derive conclusions from a set of facts. In this example, expressions of the form “if X then Y” state rules as relationships asserting that a consequent fact Y can be concluded if an antecedent fact X is known. When a set of rules is specified and a set of antecedent facts is declared then there is established a set of associations of the form “B can be concluded from A” by application of the rules of inference to the rules and antecedent facts. Such an association is typified by the assertion that B can be concluded from A when A is true and “if A then X” and “if X then B” are both rules. Determination of such associations from rules asserting relationships and antecedent facts verified or presumed to be true is accomplished by computer routines referred to as inference engines. Conventional implementations of such inference engines are computation-intensive. As a result, it is difficult to implement these routines in real-time situations where many rules may be applied to many facts in a short period of time.

### SUMMARY OF THE INVENTION

In one aspect, the present invention provides a technique to increase the processing efficiency of an inference engine for use in expert systems. For example, in one embodiment, the present invention provides a computer-implemented method for effecting an inference engine. A driver matrix is created from a set of facts and a set of rules applying to those facts. Each entry in the driver matrix indicates whether one of the facts implies another one of the facts. The driver matrix is then multiplied by itself to derive a consequent matrix. The number of entries indicating that one of the facts implies another one of the facts is counted for both matrices. If this number changes from the driver matrix to the consequent matrix, then the consequent matrix is multiplied by the driver matrix. This multiplication step is repeated until the number of entries changes does not change. The result is matrix that identifies a plurality of consequents for each fact, where the plurality of consequents includes all possible consequents for that fact.

Utilizing the preferred embodiment of the present invention allows for an expert system that can be utilized in real time applications. Unlike prior inference engines that utilize sequential processing that is slow, the preferred embodiment utilizes a look up table that includes pre-processed information. The ability to provide a table that includes all possible conclusions supports processing that is fast enough to be utilized in real-time applications.

### BRIEF DESCRIPTION OF THE DRAWINGS

The features of the present invention will be more clearly understood from consideration of the following descriptions in connection with accompanying drawings in which:

FIG. 1 is a flow chart of a first embodiment of the present invention;

FIGS. 2a-2c are matrices provided to demonstrate operation of an embodiment of the present invention;

FIG. 3 is a block diagram of an exemplary system that can utilize aspects of the present invention;

FIG. 4 is a flow chart showing the utilization of a look up table in accordance with an embodiment of the invention;

FIG. 5 shows a simplified block diagram of an expert system coupled to a network;

FIGS. 6a-6f are provided to demonstrate how embodiments of the present invention can be utilized to analyze chains in a communications network;

FIG. 7 is a flow chart showing another embodiment of the invention; and

FIGS. 8a-8c are provided to demonstrate how embodiments of the present invention can be utilized to analyze paths in a communications network.

### DETAILED DESCRIPTION OF ILLUSTRATIVE EMBODIMENTS

The making and use of the various embodiments are discussed below in detail. However, it should be appreciated that the present invention provides many applicable inventive concepts that can be embodied in a wide variety of specific contexts. The specific embodiments discussed are merely illustrative of specific ways to make and use the invention, and do not limit the scope of the invention.

The present invention includes a number of embodiments that can be applied in particular contexts. The background of an expert system will be described first followed by a description of an algorithm that can be used to work with the expert system. Several examples of applications of the algorithm are then provided.

In one aspect, application of the present invention produces the basis for implementation of a high-speed inference engine. In this embodiment, an inference engine provides the processing power for an expert system. For example, an inference engine could affirm a set of facts, apply rules relating those facts, and display the consequents of those facts.

In this context, a fact is a datum (A or B) confirmed to be true that is conditional or consequential for at least one inference of the form “A implies B.” Such inferences are rules that establish relationships among facts. Facts can be related to one another by rules. For example, a rule could be of the form “if fact A is true then fact B is true.” As a matter of language, the proposition that “fact A is true” can be called an antecedent and the conclusion that “fact B is true” can be called the consequent. Symbolically this can be written as

δ: AθB,

which can be read as “it is asserted that” (δ:) that “A implies B” (AθB). Accordingly, an expert system can be based on a model that includes a context, i.e., descriptors of facts, and rules.

The rules can be related to each by a hypothetical syllogism that states if fact A implies fact B and fact B implies fact C, then fact A implies fact C. This can be presented symbolically as

(AθB AND BθC)θ(AθC).

This is a statement of the transitivity of the relationship “implies.”

Using this set of rules, a set of consequents can be determined from a given set of facts. This determination, however, relies upon combinatorial processing. Since the number of facts and the number of rules of the form AθB may be great, the amount of processing can also be great. This causes the processing to be slow and inefficient.

In one aspect, the present invention provides a means of simplifying the application of the inference engine by pre-processing all of the rules to produce a matrix that displays, for any fact, all of its consequents. This technology can enable real-time application of expert systems.

As a first example, the present invention provides a computer implementation of a very-high speed inference engine that is obtained by 1) representing the rule base by a driver matrix as defined below, 2) multiplying a consequent matrix by the driver matrix until the number of non-zero elements does not change, and 3) using the closure matrix as the basis for look-up and extraction of conclusions from supplied fact sets.

In the preferred implementation, each of the matrices is a binary matrix, that is, each matrix is filled with 1's and 0's. Each antecedent fact is indexed as a row on the matrix and each consequent fact is indexed along the columns. Accordingly, the consequent facts of each antecedent fact can be indicated by placing a one in the column of each fact that is a consequent of a particular antecedent.

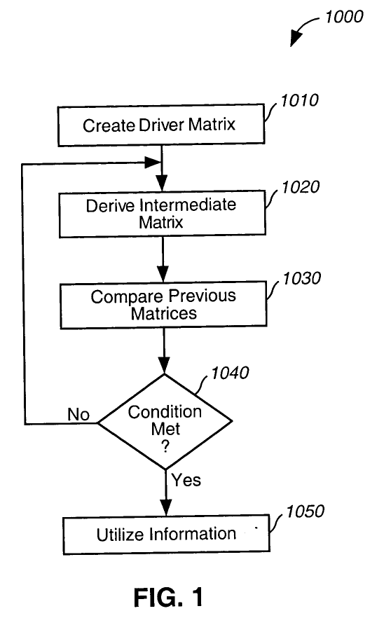

The first embodiment can be described with reference to the flow chart 1000 of FIG. 1. The driver matrix can be created from a set of facts and a set of rules applying to the facts as shown in block 1010. For example, the set of rules could be a set of implications that indicate which facts imply other facts. Some of the facts could be logical combinations of other facts (e.g., D is defined as A AND B BUT NOT C). For each antecedent fact, the row can be filled in by placing a “1” in each column of a consequent fact. In this manner, the driver matrix will provide all of the first order consequents from the rules. The driver matrix, however, does not include any consequents based upon the transitivity.

These additional consequents can be determined by multiplying the driver matrix by itself. The resulting matrix can be referred to as a consequent (or intermediate) matrix. The derivation of the consequent matrix is shown in block 1020. In the preferred implementation, matrix multiplication will be implemented by Boolean or binary multiplication, using logical AND and OR operations for the multiplications and additions of known matrix multiplication, as shown in the following rules.

| | |
|---|---|
| 0 + 0 = 0 | 0 × 0 = 0 |
| 0 + 1 = 1 + 0 = 1 | 0 × 1 = 1 × 0 = 0 |
| 1 + 1 = 1 | 1 × 1 = 1 |

The number of 1's in both the driver matrix and the consequent matrix are counted and compared. If the number of 1's is not the same, e.g., has gone up, then additional consequents were determined. It is still possible that further consequents are possible so that the multiplication and comparison steps should be repeated until the number of 1's does not change. In other words, if a condition (e.g., the number of non-zero entries remains unchanged) has not been met then the steps of deriving an consequent matrix and comparing are repeated, as shown by decision block 1040.

When the condition is met, the latest matrix multiplication did not find any additional consequents and therefore, one can conclude that the closure matrix includes all possible consequents for each antecedent fact. All conclusions will be derivable from the supplied facts, by extracting rows from the closure matrix corresponding to facts to make a sub-matrix, executing a binary OR along each column of the sub-matrix, and recording as conclusions the facts associated with any column for which the binary OR yields a 1. As will be demonstrated with a number of examples below, the information (e.g., the closure matrix) can be utilized in a variety of practical applications.

It can be proven mathematically that the algorithm of the present invention provides a comprehensive set of relationships between facts and consequents.

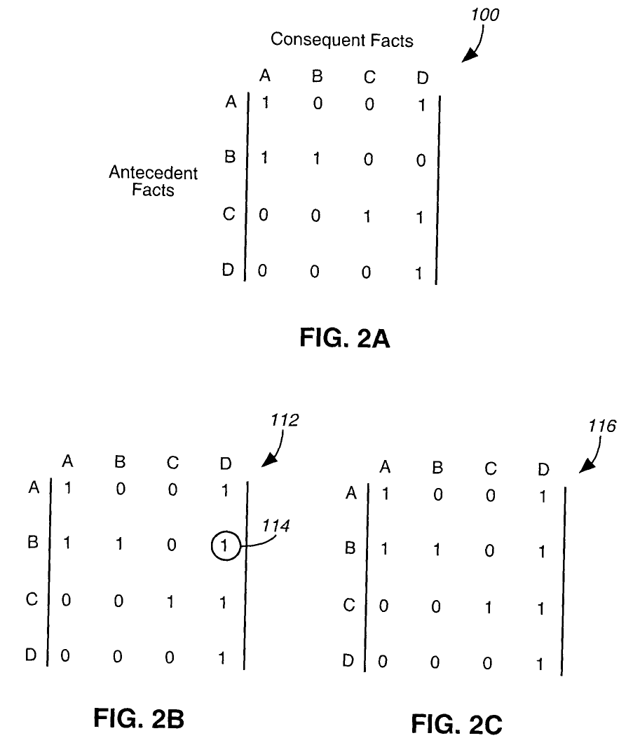

The operation of the algorithm can be illustrated by a simple example as shown in FIGS. 2a-2c. In this simple example, there are four facts A, B, C, and D. In this example there are also three rules, namely (1) if fact A is true then fact D is true (AθD), (2) if fact B is true then fact A is true (BθA), and (3) if fact C is true then fact D is true (CθD). The goal is to derive a table that provides all of the consequent facts for each antecedent fact.

FIG. 2a shows the driver matrix 100. The main diagonal is filled with l's because each fact is a consequent of itself. In other words, each matrix entry where the consequent is that same as the antecedent is filled in a ‘1.’ The remaining 1's can be filled in based on the three rules. This leads to a ‘1’ where A is the antecedent and D is the consequent, where B is the antecedent and A is the consequent and where C is the antecedent and D is the consequent. The remaining entries are filled in with 0's. It is noted that there are seven 1's in the driver matrix 100.

FIG. 2b shows the first (and, in this simple example, only) consequent matrix 112, which was derived by multiplying the driver matrix 100 by itself. This multiplication is a Boolean or binary matrix multiplication. Each entry is a logical combination, using ANDS and ORS, of a row and a column of the two matrices being multiplied. Matrix multiplication is known and the details will not be described here. See Anton, Elementary Linear Algebra, (John Wiley & Sons), 1984, p. 26, which reference is incorporated herein by reference.

Comparing the consequent matrix 112 of FIG. 2b with the driver matrix 100 of FIG. 2c, it can be seen that one entry 114 has been filled with a ‘1’. This new entry 14 has been circled in the figure. This entry 114 indicates that if fact B is true than fact D is true (BθD). This consequent is known due to the transitivity of the relationship θ, applied to facts (2) and (1) above to get:

(BθA AND AθD)θ(BθD).

It is also noted that the there are now eight 1's in the driver matrix. The fact that the number of non-zero entries has changed indicates that a new consequent has been determined. As a result the multiplication should be repeated.

FIG. 2c shows the result when the first consequent matrix 112 is multiplied by the driver matrix 110. In this case, the next matrix 116 has not changed from the previous matrix 112. When this happens, all of the possible consequents for each antecedent fact are provided in the matrix 112 and the matrix 112 is referred to as a closure matrix. This state can be determined by realizing that the matrix 116 includes eight 1's, which is the same number of 1's as in the consequent matrix 112. Since the number of 1's did not change, it can be concluded that the contents of the two matrices are the same.

In this simple example, only one consequent matrix was found (and therefore was the closure matrix). In applications that could most utilize these aspects of the present invention, a large number of consequent matrices would exist. Each consequent matrix would be determined by multiplying the previous consequent matrix by the driver matrix until a condition is met, e.g., the number of non-zero entries is constant. In other words, the algorithm includes repeatedly multiplying a result of a previous multiplication by the driver matrix until a condition is met.

The closure matrix 116 can be used to very quickly derive a great deal of information. As an example, reference can be made to the second row of the closure matrix 116. The entries (1's) in this row show that if fact B be is true (δ: B) then it can immediately be concluded facts A and D are also true (if δ: B, then δ: A and δ: D).

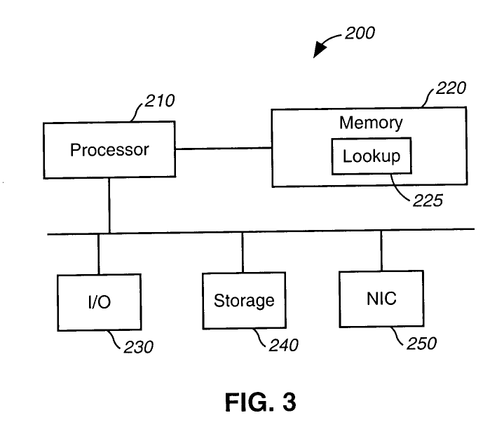

Aspects of the present invention can be used in a number of contexts. As an example, expert systems could utilize the inference engine of the present invention. FIG. 3 shows a block diagram of one such system 200.

System 200 includes a processor 210 that performs mathematical operations, such as the Boolean matrix multiplications discussed here. Processor 210 will typically also control the operations of other devices in the system. In the preferred embodiment, the processor 210 is a microprocessor such as the processor used in a personal computer or a server.

Memory 220 is coupled to the processor 210. Memory 220 can be any type of memory but is typically a dynamic random access memory (DRAM). Memory 220 stores a lookup table 225, which will comprise the closure matrix as described above. Processor 210 will access the lookup table to determine all of the possible consequents for an antecedent fact. As an example, this can be done by pulling the row of 1's corresponding to an antecedent fact and concluding as a consequent the facts associated with any column containing a 1.

A typical system 200 would also include a number of elements beside the processor 210 and memory 220. For the purpose of illustration, three of these are shown. Input/output block 230 is provided to illustrate the user interface, typically a keyboard, mouse, and display (e.g., monitor or liquid crystal display). Alternatively, or in addition, the system 200 can be accessed remotely. This feature is illustrated with network interface card 250, which is provided to couple the system 200 with other systems on a network. In the case of remote access, the NIC 250 can be considered an input/output module.

Storage unit 240 typically comprises a hard disk drive. Other storage devices, such as other magnetic storage (e.g., a floppy disk drive), optical storage (e.g., CD ROM or DVD) and/or semiconductor storage (e.g., flash memory) could be used instead. Storage unit 240 typically stores the look up table 225 data while the system is not in operation (or when the expert system software is not in use). In a typical application, the lookup table information is copied from the storage unit 240 to the memory 220 at the start of operation. In applications where the lookup table 225 is large relative to the memory 220, all or some of the lookup table may remain on the storage unit while the algorithm is operating on processor 210.

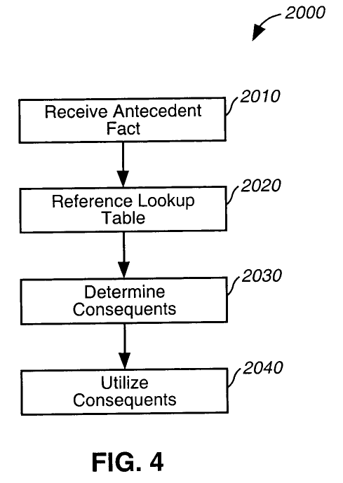

FIG. 4 provides a flow chart 2000 showing the utilization of the lookup table 225 in accordance with a preferred embodiment of the invention. As shown by block 2010, an antecedent fact is received. This fact may be received, for example, by processor 210. The lookup table 225 will be referenced, as shown by block 2020. As discussed previously, the lookup table 225 may reside in memory 220 (as shown) or elsewhere, e.g., in storage unit 240 or over the network and accessible by NIC 250.

Referring now to block 2030, the look up table 225 can be utilized to determine consequents. These consequents can then be utilized to perform a practical application. Several of these applications related to communications networks will now be discussed.

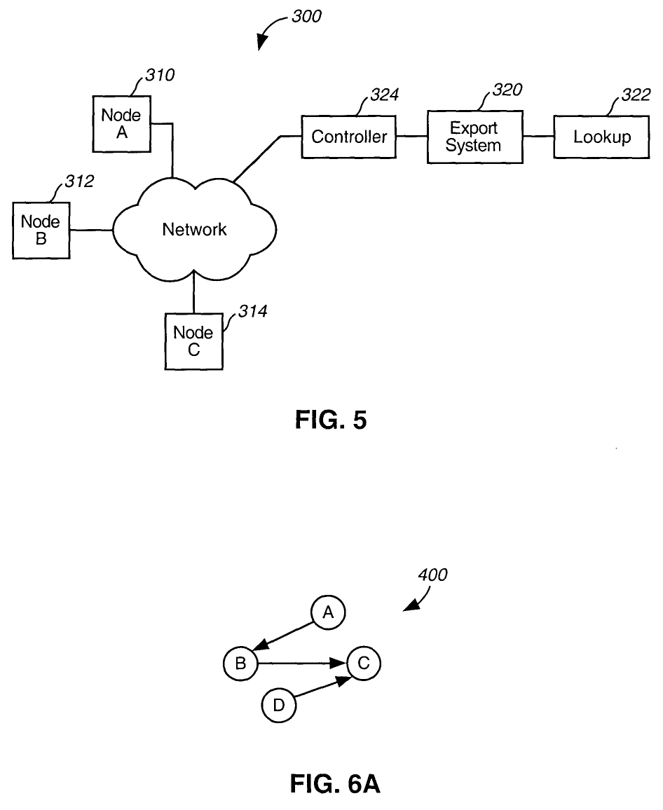

FIG. 5 shows an example of a communications network 300 that can be used to transport voice, data, video and/or other forms of information. Three nodes 310, 312 and 314 are illustratively shown. These nodes can be switches, servers, or any other piece of equipment that is in communication with the network. As an example, if the network 300 is the Internet, then nodes 310-314 could be servers.

An expert system 320 is also coupled to the network. This expert system utilizes a lookup table as described herein. The expert system 320 is also coupled to a controller 324, which serves the function of monitoring, controlling, maintaining or otherwise interfacing with the network. Specific applications are provided below. It is also understood that the expert system 320, the lookup table 322 and the controller 324 may be implemented in a single unit or spread over a number of units, which may be remotely located.

One context that can utilize embodiments of the present invention is an expert system used for the monitoring, control and/or maintenance of a communications network, e.g., a voice network, a data network or a converged network. For example, the inference engine described here can be used to select connectivity paths among locations in a network. In another example, inference engines described herein can be used to detect interactions between different services in a telecommunications network.

An example of a communications network application that can utilize aspects of the present invention is described in U.S. Pat. No. 5,946,373, which is assigned to MCI Communications Corporation, and which is incorporated herein by reference. This patent teaches a method and apparatus for detecting traffic-affecting failures in a telecommunications network; by inferring the most probable location of each such failure, given multiple alarm indicators along a network circuit; correlating circuit alarms to trunk failures, or inferring trunk failures from circuit alarms; inferring the location of major network outages by topologically correlating multiple trunk failures; and filtering alarm reporting to fault management system users such that only the most significant derived or inferred conditions are automatically displayed. The teachings of the present patent could be used as the inference engine and for other steps in the '373 patent.

Another example of an expert system that can use the teachings of the present invention is a system to determine handoffs in a wireless network. In a wireless network, such as with cellular telephone, a mobile user will traverse areas that are covered by different base stations. An inference engine can be used to process decision rules that determine when handovers are desirable. The engine can also determine appropriate power levels for the transmission to various receivers.

The techniques of the present invention can also be utilized to find associations. The changes in the matrices as a result of the intermediate Boolean multiplication steps (e.g., the difference between the matrix of FIG. 2a and the matrix of FIG. 2b) can be observed and useful information can be gleaned.

In one such application, machinery for handling the problem of identifying associations and analyzing them for patterns can be developed in the context of telecommunications networks. For example, a network operator often has access to extensive information on the node-to-node links in a particular communications network. It is desirable to (1) identify the structure of the network; and (2) determine which nodes and links represent the greatest vulnerability in the sense that their destruction would have the greatest impact on connectivity of the network.

In order to handle this problem it is desirable to create capabilities for reconstructing from what were essentially known connections between two elements of the network, effected possibly by a variety of different links, a process that would efficiently ferret out all possible end-to-end connections between any two specified nodes. By using aspects of the present invention, it is possible to analyze literally thousands of elements of data on node-to-node links. This data can be processed efficiently and quickly processed to produce all connections using only the power of an ordinary desktop PC.

It is also possible to determine the association between any two nodes. This analysis produces powerful algorithms requiring substantially less processing time and resource. This information can be used to determine where redundancy is necessary and determine which links upon which the network is most dependent.

In another application, the driver matrix can be used by law enforcement to facilitate analysis of associations among members of criminal or terrorist organizations. In this application, the methodology described above is directly transferable by replacing the terms ‘node’ with ‘person’, ‘link between node A and B’ with ‘a report of contact between person A and person B’, and ‘end-to-end connection’ with ‘association’. The fact of existence of a means for efficiently structuring uncorrelated data like this also opens up a wealth of possibilities for computer-supported analysis for inferences and indicators dependent upon an ability to identify associations and patterns thereof.

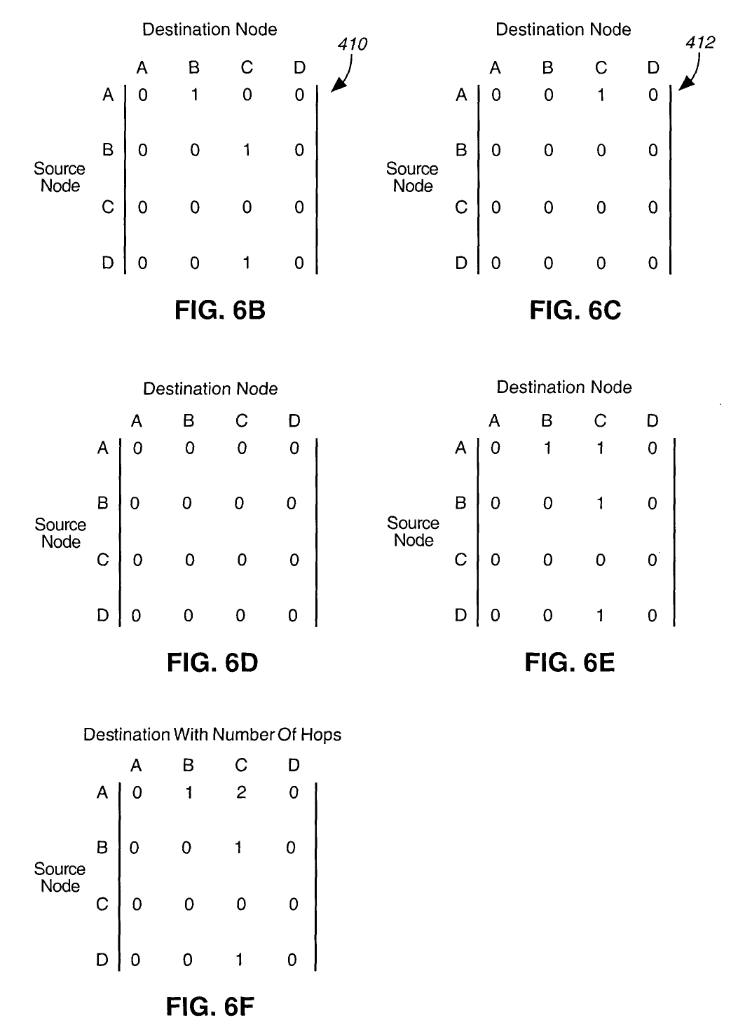

In each of the specific examples provided above, the relationship was reflexive, that is each entry was associated with itself. The present invention is also useful with non-reflexive relationships. A practical example of one such relationship is provided in FIGS. 6a-6d.

FIG. 6a shows the node connectivity of a very simple network 400. This network 400 includes four nodes A, B, C, and D that are connected by uni-directional links indicated by the arrows. For example, voice and/or data (or other information) can travel from one node to another in the direction of the link.

FIG. 6b shows the driver matrix 410 that can be derived from the network 400. In this case, a node cannot communicate information to itself and therefore the main diagonal is filled with zeroes. Each of the three links is entered into the driver matrix in the appropriate spot (where A is the source and B is the destination, where B is the source and C is the destination, and where D is the source and C is the destination).

FIG. 6c shows the first consequent matrix 412, which was generated by multiplying the driver matrix 410 by itself. The first consequent matrix 412 provides at least two pieces of information. First, it indicates that information can flow from node A to node C. It also indicates that the information starting at node A will reach node C in two hops (since this is the first consequent matrix). This information can be very useful in finding the shortest route between two nodes. This is especially useful in large networks that include thousands of nodes connected together by thousands of links (or more).

FIG. 6d is provided to show the second consequent matrix 414, which in this case is also the closure matrix 414. In this case the closure matrix includes all zero entries indicating that each of the chains has been exhausted. Had the network included any nodes that could be connected by three hops, then there would have been ones in the second consequent matrix indicating which two nodes could receive information in three hops.

FIG. 6e is provided to show all of the possible connections between nodes in the network. This matrix was generated by summing (logical OR) the driver matrix 410 with each of the consequent matrices 412 (only one in this case). In another embodiment, each of the consequent matrices could be filled with an integer that is derived by counting the number of matrices used to derive that matrix. For example, matrix 410 is the driver matrix so one matrix was used to derive it. Matrix 412 is the driver matrix multiplied by itself and therefore two matrices were used to derive it. In other words, each non-zero entry in consequent matrix 412 would be a “2.” This entry could be treated as a logical one for the purpose of the binary operations but could also be used to track the number of hops.

FIG. 6f shows the final matrix when the number of hops is included in the entries. In this case, it is clear the information can travel from A to B in one hop and from A to C in two hops. Once again, this table could be quite useful in summarizing a very complex network (where each entry could include more than one number if there is more than one path between two given nodes).

This information can be used in a number of ways. For example, the number of hops can be provided in a lookup table that can be used by the communications system when determining how to route data. The information can also be used when the system malfunctions. For example, if a greater than optimal amount of traffic is traveling through a given route, the system will re-route information over a similarly efficient path. This same technique could be used when one of the paths fails.

Another practical application of embodiments of the invention is in the detection of fraud. A perpetrator of fraud might originate a call (or Internet packet) and bounce it around the world so that it is difficult to detect the origin. If this happens more than once, the date and time of each occurrence can be captured. Since each destination can have multiple origins, it can be difficult to determine where the call originated. Using aspects of the present invention, however, common origins can be determined, increasing the probability that the origin in question can be determined.

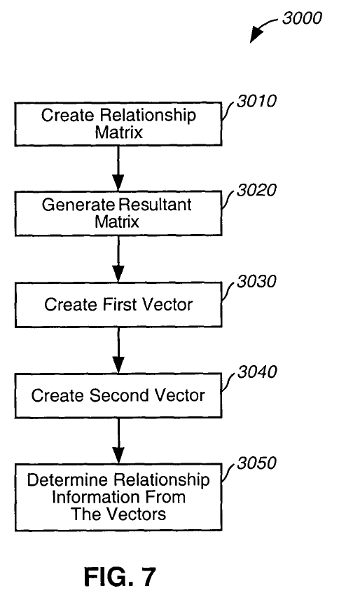

In yet another aspect, the present invention provides for rapid determination of the associations derived from a transitive relationship and supports creation of efficient algorithms for determining the shortest route(s) from one node to another in a multiply connected network. Aspects of the invention also provide for finding those route(s). The flow chart 3000 of FIG. 7 can be used in following this process. In this embodiment, the process involves creation of a relationship matrix R for the non-reflexive relationship between nodes in the network, “is directly connected to”. This step is shown in block 3010. In applications to finding the shortest node-to-node connection from a node A to a node X in the network, the following process based on R is used.

In R, the column corresponding to the origin node A and the row corresponding to the destination node X are set to be all Os. This step generates a closure matrix as shown by block 3020. The closure matrix, denoted here DR, reflects a modification of the description of connections in the network to exclude anything coming into A or leaving X.

A first vector V₀ is created as shown in block 3030. The vector, V₀, comprises all zeros except for a 1 in the position representing the column associated with the origin A by the matrix DR. A second vector or, more likely, set of vectors is created by successively multiplying the first vector V₀. Creation of the second vector is shown in block 3040. This multiplication schema creates a series of vectors, defined and created as follows:

$$\begin{matrix}{V}_{1} = {V}_{0} * DR , \\ {V}_{2} = {V}_{1} * DR , \\ ⋯ \\ {V}_{j} = {V}_{j - 1} * DR ,\end{matrix}$$

where * denotes Boolean matrix multiplication.

The process continues until the first result V_{S} for which there is a 1 in the position corresponding to the column associated with the destination, X. The value S represents the fewest node-to-node hops necessary to connect node A and node X.

To identify the possible connections, the process begins by setting V_{X} to be the vector comprising all 0s except for the position representing the column associated with the destination X. This starting value is used to produce a vector defined by:

Cs=V_{S-1}\hat{ }(V_{X*R),}

where X\hat{ }Y represents the component by component Boolean product of two vectors of equal length.

If n is the number of 1's in the vector C_{S}, then the vector C_{S} is transformed into a set of vectors

{CC_{S}(i)|i=1, . . . n},

where each vector CC_{S}(i) includes all 0's, except for one of the non-zero positions in C_{S}. In other words if the vector C_{S} includes three non-zero entries than n=3 creating three vectors CC_{S}(1), CC_{S}(2) and CC_{S}(3). Each of these three vectors would include one non-zero entry corresponding with the three non-zero entries of C_{S} (and so that none of the CC_{S}(i) vectors are the same).

The calculation from above is then repeated for each of the n members of the CC_{S} set, to get:

{CC_{S-1}(i)=V_{S-2}\hat{ }(CC_{S}(i)*R)i=1, . . . n}.

Each C_{S-1}(i) is then broken down into a collection of vectors containing all 0's except for a single 1, just as was done to generate CC_{S}(i) from C_{S} as shown above. This process continues then until C₀ is calculated, in which case all vectors from the previous step map into the original vector V₀, validating the end of the reconstruction.

As can be seen, the steps above provide information relating to the relationship between nodes in the network (see block 3050). This information can be used for a number of practical applications. For example, in the case of a communication network, the information can be used to control the flow of communications traffic through the network.

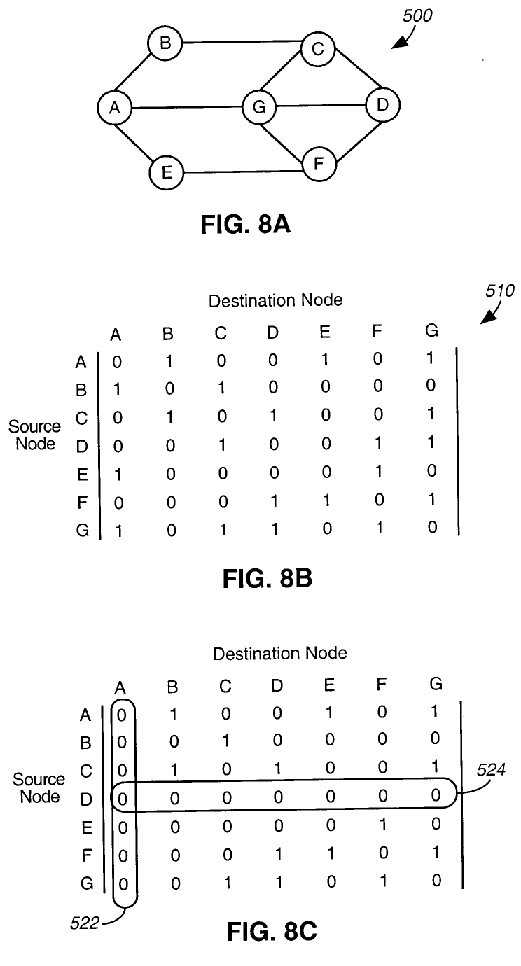

FIGS. 8a-8c display this process for a simple network. FIG. 8a shows a simple network 500 that includes seven nodes labeled A-G. FIG. 8b shows the relationship matrix R (or driver matrix R), which is labeled with reference numeral 510. This matrix 510 was generated using the same techniques as discussed above. Unlike the network 400 (FIG. 4a), it is assumed that each of the links in network 500 is bi-directional. For example, information can flow both from node A to node G and also from node G to node A. Either of the methods would work with bi-directional or unidirectional links (or combinations of both).

In this example, it is desired to find the shortest route between network node A and network node D (i.e., the least number of hops). FIG. 8c shows the closure matrix DR (labeled with reference numeral 520) that was derived by setting to zero all entries in column A (where node A is the destination) and the row D (where node D is the source). To assist in following in the figures column A has been labeled with reference numeral 522 and row D with reference numeral 524.

As discussed above, the vector V₀ is generated to include a 1 in the position representing the column associated with original A and the remaining columns being zero. Accordingly, in the example the vector V₀ would be:

V₀=[1 0 0 0 0 0 0 0]

A set of vectors can now be created by successively multiplying the vector V₀ by the matrix DR (matrix 520 of FIG. 8c). These vectors will now be shown.

V₁=V₀*DR=[0 1 0 0 1 0 1]

V₂=V₁*DR=[0 0 1 1 0 1 0]

V₃=V₂*DR=[0 1 0 1 1 0 1]

There is much information that can be gleaned from these vectors. For example, vector V₁ indicates that node A is connected directly to nodes B, E, and G. Vector V₂ indicates that node A can reach nodes C, D and F in two hops (one intermediate node). Similarly, vector V₃ indicates that node A can reach nodes B, D, E and G in three hops (two intermediate nodes). Similar vectors could be created for further information.

In each of the vectors V₁, V₂ and V₃, the fourth entry, which corresponds to the destination node D, has been underlined. From these vectors, it can be seen that the shortest path from node A to node D would be in two hops. The path cannot be made in one hop since the fourth entry in vector V₁ is a “0.” It can be made in either two hops or three hops since the fourth entry in vectors V₂ and V₃ are both ones.

This example demonstrates the value of these aspects of the present invention in finding the length of the shortest path between two nodes in a network, such as a communications network. In other situations, one may be interested in not only the length of the path but also the path itself. As explained above, the present invention includes embodiments for finding the path.

From the computation above, it is known that there is a two-step path from A to D. Accordingly, this path can be found by determining a vector Vₓ that is created by setting a 1 in the position of the destination node (D in the case) and the other entries to 0. In this case, Vₓ would be defined as:

Vₓ=[0 0 0 1 0 0 0].

This starting value is used to produce a vector C₂, since it is known that the shortest path takes two steps. Referring to the results above and the matrix R from FIG. 8b, vector C₂ is defined as:

C₂=V₁\hat{ }(V_{X}*R)=[0 0 0 0 0 0 1].

This result indicates that the shortest path to node D came from node G (since the G entry of the vector is a 1). The next step is to find the source node that connected to node G. To continue this process, a vector C₁ (referred to as C_{S-1} above) is determined as follows:

C₁=V₀\hat{ }(C₂*R)=[1 0 0 0 0 0 0].

The vector C₁ indicates that node A was the source for node G (since the A entry of the vector is a 1). Accordingly, the two-step path can be determined as

A→G→D.

This case was relatively simple because there was only one two-step path. To demonstrate the situation when more than one path can exist, the computation will be repeated to determine the three-step path(s). As before, C₃ can be defined as:

C₃=V₂\hat{ }(V_{X}*R)=[0 0 1 0 0 1 0]

This result indicates that there are two three-step paths. One of these paths routed through node C while the other routed through node F. Accordingly, the determination can be split into two determinations—one for the path that traverses node C and another for the path that traverses node F. These leads to two C₂ vectors defined as

CC₂(1)=[0 0 1 0 0 0 0] for the path through node C; and

CC₂(2)=[0 0 0 0 0 1 0] for the path through node F.

For the node C path, the second vector C₂ can be calculated as:

C₂(1)=V1\hat{ }(CC₂(1)*R)=[0 1 0 0 0 0 1]

The matrix C₂(1) indicates that there are two more paths into node C, namely from node B and from node G. As a result two more calculations are performed.

C₁(1)=V₀\hat{ }([0 1 0 0 0 0 0]*R)=[1 0 0 0 0 0 0]; and

C₁(2)=V₀\hat{ }([0 0 0 0 0 0 1]*R)=[1 0 0 0 0 0 0].

These results indicate that both paths had a common source of node A. Taking these results and repeating these steps for the path through node F indicates that there are four three-step paths from node A to node D. These four paths are as follows:

A→B→C→D

A→G→C→D

A→E→F→D

A→G→F→D

For this rather simple network, these four paths can be verified by viewing the network diagram 500 of FIG. 8a. This method could also be applied to a much more complex network, for example one that includes hundreds of nodes. Using this method provides a relatively straightforward way to find all (or some, e.g., one) of the paths between two nodes. For example, an algorithm can be run on a computer(s) that control a network to ensure that the shortest and/or most efficient path is being used. If a failure occurs in one of the links, the system could recalculate the link using the alternatives calculated above. In one embodiment, the paths are calculated in advance and stored in a memory. Once a failure is detected, a lookup to that memory can be made and the traffic can be quickly re-routed.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of using an expert system to control or maintain a communications network, the method comprising:
receiving at least one antecedent fact, the antecedent fact comprising an observable fact relating to a piece of equipment or activity of the communications network;
determining consequents related to the at least one antecedent fact by referencing a lookup table, the lookup table including a plurality of antecedent facts and, associated with each antecedent fact, information regarding all possible consequents of that antecedent fact; and
using the determined consequents to control or maintain the communications network.

2. The method of claim 1 wherein using the determined consequents to control or maintain the communications network comprises monitoring at least a portion of the communications network using at least one determined consequent.

3. The method of claim 1 wherein using the determined consequents to control or maintain the communications network comprises controlling at least a portion of the communications network using at least one determined consequent.

4. The method of claim 1 wherein using the determined consequents to control or maintain the communications network comprises maintaining at least a portion of the communications network using at least one determined consequent.

5. The method of claim 1 wherein the communications network comprises a wireless network, wherein using the determined consequents to control or maintain the communications network comprises determining handoffs in the wireless network using at least one determined consequent.

6. The method of claim 5 and further comprising determining power levels for transmission to various receivers using at least one determined consequent.

7. The method of claim 1 and further comprising pre-processing a set of rules relating a plurality of antecedent facts to a plurality of consequents, the at least one antecedent fact being one of the plurality of antecedent facts, wherein contents of the lookup table are based upon results of the pre-processing.

8. The method of claim 1 and further comprising generating the lookup table, wherein generating the lookup table comprises:
compiling a plurality of antecedent facts including said at least one antecedent fact;
determining whether each antecedent fact is related to others of the antecedent;
creating a driver matrix that summarizes relationships between items in the plurality of items;
generating a consequent matrix by multiplying the driver matrix by itself;
multiplying the consequent matrix by the driver matrix;
analyzing the result of the multiplying step to determine if a condition has been met;
if the condition has not been met, repeatedly multiplying a result of a previous multiplication by the driver matrix until the condition is met; and
after the condition is met, generating entries for the lookup take by using information based on a final result of the multiplying.

9. A computer-implemented method of controlling a communications network, the method comprising:
creating a driver matrix from a set of facts and a set of rules applying to the facts wherein each entry in the driver matrix indicates whether one of the facts implies another one of the facts, and wherein each of the facts comprises a observable fact relating to a communications network;
multiplying the driver matrix by itself to derive a consequent matrix;
comparing the driver matrix to the consequent matrix to determine relationships between facts in the set of facts; and
modifying routing of information through the communications network based upon the relationships determined in the comparing step.

10. The method of claim 9 and further comprising:
multiplying the consequent matrix by the driver matrix to derive a second consequent matrix; and
comparing the consequent matrix to the second consequent matrix to determine relationships between facts in the set of facts.

11. The method of claim 9 wherein the set of rules relates ones of the set of facts to other ones of the set of facts.

12. A computer implemented method for analyzing relationships between nodes in a communications network, the method comprising:
(A) creating a driver matrix from a set of facts and a set of rules applying to the facts wherein each entry in the driver matrix indicates whether one of the facts implies another one of the facts and wherein each fact relates to an observable characteristic of the communications network;
(B) counting a number of driver matrix entries that indicate that one of the facts implies another one of the facts;
(C) multiplying the driver matrix by itself to derive a consequent matrix;
(D) counting a number of consequent matrix entries that indicate that one of the facts implies another one of the facts; and
(E) if the counted number of consequent matrix entries is greater than the counted number of driver matrix entries then repeating the steps of:
(a) multiplying a most previous consequent matrix by the driver matrix to derive a next consequent matrix,
(b) comparing the number of next consequent matrix entries that indicate that one of the facts implies another one of the facts with the number of most previous consequent matrix entries that indicate that one of the facts implies another one of the facts, and
(c) redefining the next consequent matrix as the most previous consequent matrix, until the counted number of next consequent matrix entries is equal to the counted number of most previous consequent matrix entries.

13. The method of claim 12 wherein creating a driver matrix comprises creating a matrix of 1's and 0's and wherein counting a number of driver matrix entries and counting a number of consequent matrix entries comprise counting a number of 1's.

14. The method of claim 12 and further comprising storing a lookup table derived from a closure matrix that results from step (E), the lookup table including a number of facts, the lookup table also including a plurality of consequents for each fact, the plurality of consequents including all possible consequents for that fact.

15. The method of claim 14 and further comprising using the lookup table in an expert system.

16. The method of claim 15 and further comprising using the lookup table in a fault detection system in the communications network.

17. A method of analyzing a communications network, the method comprising:
creating a relationship matrix, the relationship matrix including rows and columns of entries that represent the relationships between nodes in the communications network;
generating a closure matrix by setting each of the entries in a first one of the rows to zero and by setting each of the entries in a first one of the columns to zero;
creating a first vector that includes a number of entries equal to a number of entries in a row of the relationship matrix wherein one of the entries in the first vector is a “1” and the remaining entries are set to zero;
generating a second vector by multiplying the first vector by the closure matrix, the second vector providing information relating to the relationship between nodes in a the network; and
using the information relating to the relationship to control the flow of communications traffic through the communications network.

18. The method of claim 17 and further comprising generating a plurality of vectors Vj where j is an integer and vectors Vj are calculated as Vⱼ=Vⱼ₋₁*DR, where DR is the closure matrix.

19. The method of claim 17 wherein analyzing a network comprises determining the length of a shortest path between two nodes in the network.

20. The method of claim 17 wherein analyzing a network comprises determining nodes in a path between two nodes in the network.

21. An expert system comprising:
a processor;
a memory unit coupled to the processor, the memory unit storing a lookup table, the lookup table including a plurality of antecedent facts and, associated with each antecedent fact, information regarding all possible consequents of that antecedent fact; and
an input/output module coupled to the processor.

22. The system of claim 21 wherein the expert system is used to control a communications network.

23. The system of claim 21 wherein the processor executes computer code to detect traffic-affecting failures in a communications network.

24. The system of claim 21 wherein the processor executes computer code to determine handoffs in a wireless communications network.

25. The system of claim 21 wherein the memory unit is formed from a dynamic random access memory.

26. The system of claim 21 wherein the memory unit comprises a hard disk drive.

27. The system of claim 21 wherein the input/output module comprises a communications port.

28. The system of claim 21 wherein the input/output module comprises a visual display.

29. The system of claim 21 wherein the processor executes a real-time application of an expert system.

30. An inferencing system comprising:
means for obtaining facts that are antecedent to a known set of relationships;
means for identifying logically derivable conclusions from the observable facts, wherein the means for identifying includes a lookup table in which all consequents of any antecedents are immediately derivable; and
means for utilizing the derivable conclusions.

31. The system of claim 30 wherein the means for obtaining facts comprises means for observing facts related to a communications network.

32. The system of claim 31 wherein the means for obtaining facts comprises means for observing facts related to a wireless communications network.

33. The system of claim 32 wherein the means for obtaining facts comprises means for observing facts related to handoffs in the wireless communications network.

34. The system of claim 31 the wherein means for obtaining facts comprises means for observing facts related to traffic-affecting failures in the communications network.

35. The system of claim 30 wherein the means for identifying comprises a processor coupled to a memory, the memory storing the lookup table.

36. The system of claim 35 wherein the means for utilizing the derivable conclusions comprises the processor.

37. The system of claim 30 wherein the means for utilizing comprises a processing system that determines routing information through a communications network.
